(19) United States
(12) Patent Application Publication
(10) Pub. No.: US 2016/0140777 A1
(43) Pub. Date: May 19, 2016

(54) BROADCASTING UNIT, APPARATUS FOR BROADCASTING AND COMMUNICATION, AND VEHICLE HAVING THE SAME

(71) Applicant: Hyundai Motor Company, Seoul (KR)

(72) Inventor: Sang Heun Lee, Seoul (KR)

(21) Appl. No.: 14/718,925

(22) Filed: May 21, 2015

(30) Foreign Application Priority Data
Nov. 17, 2014 (KR) 10-2014-0160164

(51) Int. Cl. G07C 5/00; H04H 40/27; H04H 20/62; H04H 20/86; H04H 20/72

(52) U.S. Cl. CPC G07C 5/008; H04H 20/86; H04H 20/72; H04H 20/62; H04H 40/27

(57) ABSTRACT

A vehicle includes: a single antenna, a broadcasting unit configured to receive a broadcast signal through the single antenna, a communication unit configured to transmit and receive a communication signal through the single antenna, and at least one cutoff unit provided on an input side of the broadcasting unit and configured to cut-off an inflow of the communication signal to the broadcasting unit.

### CROSS-REFERENCE TO RELATED APPLICATION

This application claims priority to and the benefit of Korean Patent Application No. 10-2014-0160164, filed on Nov. 17, 2014 in the Korean Intellectual Property Office, the disclosure of which is incorporated herein in its entirety by reference.

### BACKGROUND

1. Technical Field

Embodiments of the present disclosure relate generally to a vehicle, and more particularly, to a vehicle having a broadcasting unit and a communication unit.

2. Description of the Related Art

Antennas used in vehicles may be implemented in various manners based on the purpose and use of the antennas. For example, a rod-type antenna, a shark fin-type antenna, an antenna that is also used as a thermal line, or the like may be used. In the case of the shark fin-type antenna, a plurality of antennas for transmitting and receiving a plurality of different types of signals may be installed in an internal space. A multi-band antenna for transmitting and receiving a plurality of different signals may also be used as a single antenna.

In this manner, the mixing of an undesired signal may occur in a section in which frequency bands overlap when a plurality of different signals are transmitted and received using one multi-band antenna. In addition, even when two or more single band antennas are separately used, the mixing of an undesired signal may occur because distances among a plurality of antennas are adjacent to each other when a plurality of antennas are integrated within the same casing as in the shark fin-type antenna.

### SUMMARY

An object of the present disclosure is to prevent an undesired signal from being mixed when a multi-band antenna is used. Another object of the present disclosure is to prevent an undesired signal from being mixed even when separate single band antennas adjacent to each other are used.

According to embodiments of the present disclosure, there is provided a vehicle including: a single antenna; a broadcasting unit configured to receive a broadcast signal through the single antenna; a communication unit configured to transmit and receive a communication signal through the single antenna; and at least one cutoff unit provided on an input side of the broadcasting unit and configured to cut-off an inflow of the communication signal to the broadcasting unit.

The single antenna may be a multi-band antenna.

The broadcast signal may be a radio broadcast signal, and the communication signal may be a telematics signal.

The at least one cutoff unit may include a band cutoff filter configured to cut-off a signal of a carrier frequency band of the telematics signal.

The at least one cutoff unit may include a band isolator configured to cut-off a signal of a carrier frequency band of the telematics signal.

The band isolator may be installed in a direction in which an inflow of the signal of the carrier frequency band of the telematics signal to the broadcasting unit is cut-off.

The at least one cutoff unit may include at least one band cutoff filter and at least one band isolator connected in series to cut-off a signal of a carrier frequency band of the telematics signal.

The vehicle may further include: another broadcasting unit configured to receive another broadcast signal through the single antenna.

Furthermore, according to embodiments of the present disclosure, there is provided a vehicle including: a first antenna; a second antenna installed near the first antenna; a broadcasting unit configured to receive a broadcast signal through the first antenna; a communication unit configured to transmit and receive a communication signal through the second antenna; and at least one cutoff unit provided on an input side of the broadcasting unit and configured to cut-off an inflow of the communication signal to the broadcasting unit.

The broadcast signal may be a radio broadcast signal, and the communication signal may be a telematics signal.

The at least one cutoff unit may include a band cutoff filter configured to cut-off a signal of a carrier frequency band of the telematics signal.

The at least one cutoff unit may include a band isolator configured to cut-off a signal of a carrier frequency band of the telematics signal.

The band isolator may be installed in a direction in which an inflow of the signal of the carrier frequency band of the telematics signal to the broadcasting unit is cut-off.

The at least one cutoff unit may include at least one band cutoff filter and at least one band isolator connected in series to cut-off a signal of a carrier frequency band of the telematics signal.

Furthermore, according to embodiments of the present disclosure, there is provided a broadcasting unit including: a reception section configured to share a single antenna with a communication unit and receive a broadcast signal through the single antenna; and at least one cutoff unit provided on an input side of the reception section and configured to cut-off an inflow of a communication signal to the reception section.

The single antenna may be a multi-band antenna.

The broadcast signal may be a radio broadcast signal, and the communication signal may be a telematics signal.

The at least one cutoff unit may include a band cutoff filter configured to cut-off a signal of a carrier frequency band of the telematics signal.

The at least one cutoff unit may include a band isolator configured to cut-off a signal of a carrier frequency band of the telematics signal.

The band isolator may be installed in a direction in which an inflow of the signal of the carrier frequency band of the telematics signal to the broadcasting unit is cut-off.

Furthermore, according to embodiments of the present disclosure, there is provided an apparatus for broadcasting and communication including: a single antenna; a broadcasting unit configured to receive a broadcast signal through the single antenna; a communication unit configured to transmit and receive a communication signal through the single antenna; and at least one cutoff unit provided on an input side of the broadcasting unit and configured to cut-off an inflow of the communication signal to the broadcasting unit.

The single antenna may be a multi-band antenna.

The broadcast signal may be a radio broadcast signal, and the communication signal may be a telematics signal.

Furthermore, according to embodiments of the present disclosure, there is provided a vehicle including: a first antenna; a second antenna installed near the first antenna; a broadcasting unit configured to receive a broadcast signal through the first antenna; a communication unit configured to transmit and receive a communication signal through at least one of the first antenna and the second antenna; and at least one cutoff unit provided on an input side of the broadcasting unit and configured to cut-off an inflow of the communication signal to the broadcasting unit.

Furthermore, according to embodiments of the present disclosure, there is provided a multi-input, multi-output (MIMO) apparatus including: a first antenna; a second antenna installed near the first antenna; a broadcasting unit configured to receive a broadcast signal through the first antenna; a communication unit configured to transmit and receive a communication signal through at least one of the first antenna and the second antenna; and at least one cutoff unit provided on an input side of the broadcasting unit and configured to cut-off an inflow of the communication signal to the broadcasting unit.

Furthermore, according to embodiments of the present disclosure, there is provided a vehicle including: a single multi-band antenna; a radio unit configured to receive an amplitude modulation (AM) radio broadcast signal though the single multi-band antenna; a telematics unit configured to transmit and receive a telematics communication signal through the single multi-band antenna; and at least one telematics band cutoff filter or at least one telematics band isolator installed on an input side of the radio unit and configured to cut-off an inflow of an AM-band modulation signal included in the telematics communication signal to the radio unit through a communication path.

According to the above-described aspects of the present disclosure, it is possible to prevent an undesired signal from being mixed when a multi-band antenna is used. Furthermore, it is possible to prevent an undesired signal from being mixed even when separate single band antennas adjacent to each other are used.

### BRIEF DESCRIPTION OF THE DRAWINGS

These and/or other aspects of the present disclosure will become apparent and more readily appreciated from the following description of the embodiments, taken in conjunction with the accompanying drawings of which:

FIG. 1 is a diagram illustrating an integrated antenna for a vehicle according to embodiments of the present disclosure;

FIG. 2 is a diagram illustrating a structure of the integrated antenna illustrated in FIG. 1;

FIG. 3 is a diagram illustrating an apparatus for broadcasting and communication of a vehicle according to embodiments of the present disclosure;

FIG. 4 is a diagram illustrating an apparatus for broadcasting and communication of a vehicle according to embodiments of the present disclosure;

FIG. 5 is a diagram illustrating an apparatus for broadcasting and communication of a vehicle according to embodiments of the present disclosure;

FIG. 6 is a diagram illustrating an apparatus for broadcasting and communication of a vehicle according to embodiments of the present disclosure;

FIG. 7 is a diagram illustrating an apparatus for broadcasting and communication of a vehicle according to embodiments of the present disclosure;

FIG. 8 is a diagram illustrating an apparatus for broadcasting and communication of a vehicle according to embodiments of the present disclosure;

FIG. 9 is a diagram illustrating an apparatus for broadcasting and communication of a vehicle according to embodiments of the present disclosure; and

FIG. 10 is a diagram illustrating noise characteristics of an antenna in a vehicle according to embodiments of the present disclosure.

### DETAILED DESCRIPTION OF THE EMBODIMENTS

Hereinafter, exemplary embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control section. The term “control section” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control section in conjunction with one or more other components, as would be appreciated by a person of ordinary skill in the art.

Referring now to the disclosed embodiments, in order to transmit and receive signals of different frequency bands in broadcast and communication fields, a single multi-band antenna is used or a plurality of single band antennas are integrated within one module. Because signals of different frequency bands are transmitted to and received from a single antenna in the case of the single multi-band antenna, it is natural to provide a countermeasure for the mixing of an undesired signal. In addition, it is necessary to dispose a plurality of antennas at very close distances even when a plurality of single band antennas are integrated in one module. Even in this case, a countermeasure for the mixing of the undesired signal is required.

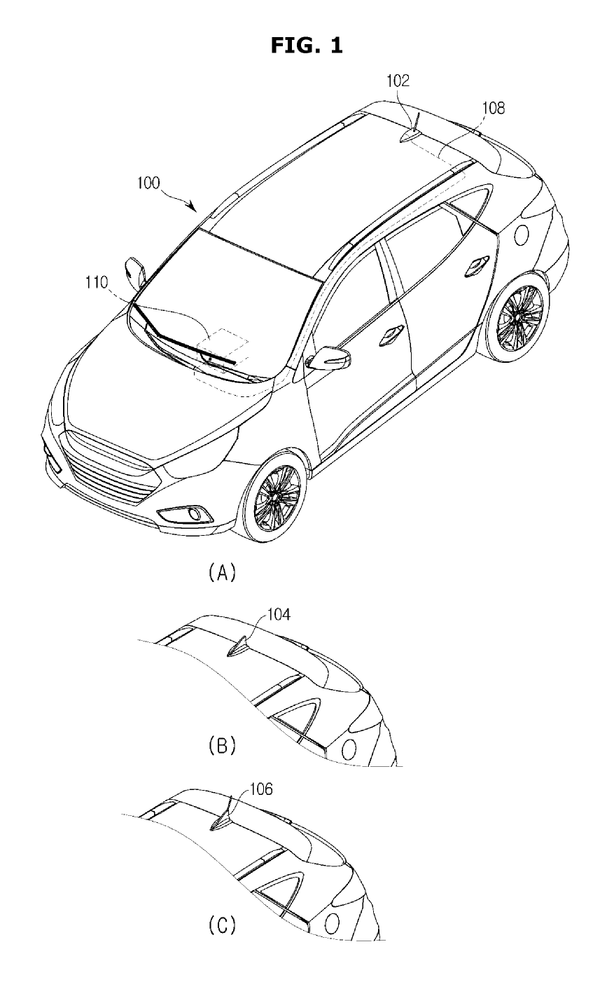

FIG. 1 is a diagram illustrating an integrated antenna for a vehicle according to embodiments of the present disclosure. Reference numerals 102, 104, and 106 of FIG. 1 denote various types of integrated antennas of the vehicle according to embodiments of the present disclosure. The integrated antenna 102 illustrated in (A) of FIG. 1 is a rod-type antenna, the integrated antenna 104 of (B) of FIG. 1 is a shark fin-type antenna, and the integrated antenna 106 of (C) of FIG. 1 is a combination type antenna in which the rod-type antenna and the shark fin-type antenna are combined.

First, (A) of FIG. 1 is a diagram illustrating an installation state of the integrated antenna 102 for the vehicle and a cable layout. As illustrated in (A) of FIG. 1, the integrated antenna 102 for the vehicle can be fixedly installed on a roof of the vehicle 100. The integrated antenna 102 is connected to a head unit 110 (e.g., an audio/navigation/multimedia device or the like) at the side of a driver seat through a cable 108 for a signal transfer. The cable 108 can be disposed according to a lower space of the roof or an internal space of a pillar of the vehicle 100.

As illustrated in (B) and (C) of FIG. 1, even when a type of the integrated antenna is different, an installation position of the integrated antenna and a wiring form of the cable basically conforms to a structure illustrated in (A) of FIG. 1. Of course, the installation position of the integrated antenna and the cable wiring may differ in consideration of a design of the vehicle 100, signal transmission/reception efficiency, and the like.

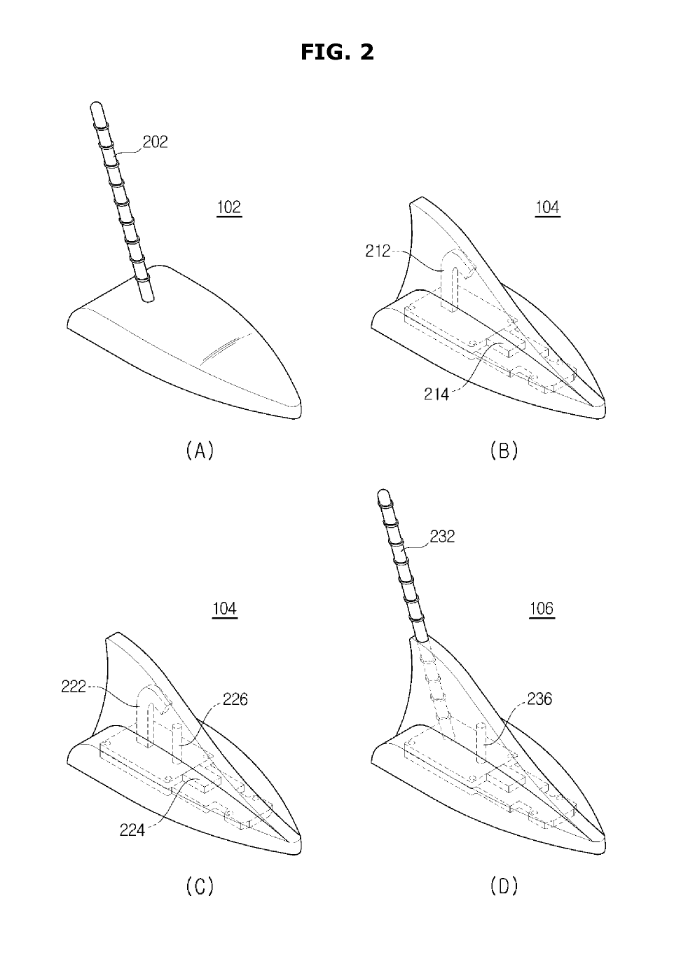

FIG. 2 is a diagram illustrating a structure of the integrated antenna illustrated in FIG. 1. (A) of FIG. 2 illustrates the integrated antenna 102 of a rod antenna type illustrated in (A) of FIG. 1. In the integrated antenna 102, a part of a rod 202 operates as a multi-band antenna to perform both a function of receiving a radio signal and a function of transmitting and receiving a telematics signal. (B) of FIG. 2 illustrates the integrated antenna 104 of a shark fin antenna type illustrated in (B) of FIG. 1. In an internal space of the integrated antenna 104, a multi-band antenna 212 for performing both a function of receiving a radio signal and a function of transmitting and receiving a telematics signal is installed and a global positioning system (GPS) antenna 214 (e.g., single band antenna) for receiving a GPS signal is installed. (C) of FIG. 2 illustrates another integrated antenna 104 of the shark fin-type illustrated in (B) of FIG. 1. In an internal space of the integrated antenna 104, a radio reception antenna 222 (e.g., single band antenna) responsible for a function of receiving a radio signal is installed, a GPS antenna 224 (e.g., single band antenna) for receiving a GPS signal is installed, and a telematics transmission/reception antenna 226 responsible for a function of transmitting and receiving a telematics signal is installed. (D) of FIG. 2 illustrates a combination type integrated antenna 106 illustrated in (C) of FIG. 1. A rod antenna 232 responsible for a function of receiving a radio signal is installed to start from an internal space of a casing of the integrated antenna 106 and be partially externally exposed. Along with this, a telematics transmission/reception antenna 236 responsible for a function of transmitting and receiving a telematics signal is installed in the internal space of the casing.

A modulation frequency band of an AM radio signal is 535 KHz to 1605 KHz. The telematics signal uses a carrier frequency of about 800 MHz to 900 MHz or about 1.7 GHz to 2.2 GHz. Among these, an operation modulation frequency (e.g., frequency carrying actual information) operates in a band of several hundred KHz. That is, it can be seen that a modulation frequency band (e.g., a band of several hundred KHz) partially overlap a modulation frequency band (e.g., 535 KHz to 1605 KHz) of an AM radio signal. Accordingly, because the inflow of a signal of the modulation frequency band of a telematics transmission signal into a radio unit may occur in a transmission process, the following embodiments are proposed as the countermeasure for the signal inflow.

In embodiments according to the present disclosure, at least one cutoff unit is provided on an input side of a broadcasting unit so that the inflow of a communication signal into the broadcasting unit is cut-off in a structure in which the broadcasting unit for receiving a broadcast signal and a communication unit for transmitting and receiving the communication signal share a single antenna. Here, the broadcasting unit may be a radio unit. In addition, the communication unit may be a telematics unit. The broadcast signal may be an AM radio broadcast signal. In addition, the communication signal may be a telematics signal. In addition, the cutoff unit may be a telematics band cutoff filter. The telematics band cutoff filter performs a cutoff operation of disabling both the reception and transmission of a desired signal of a specific frequency band (i.e., bidirectional cutoff).

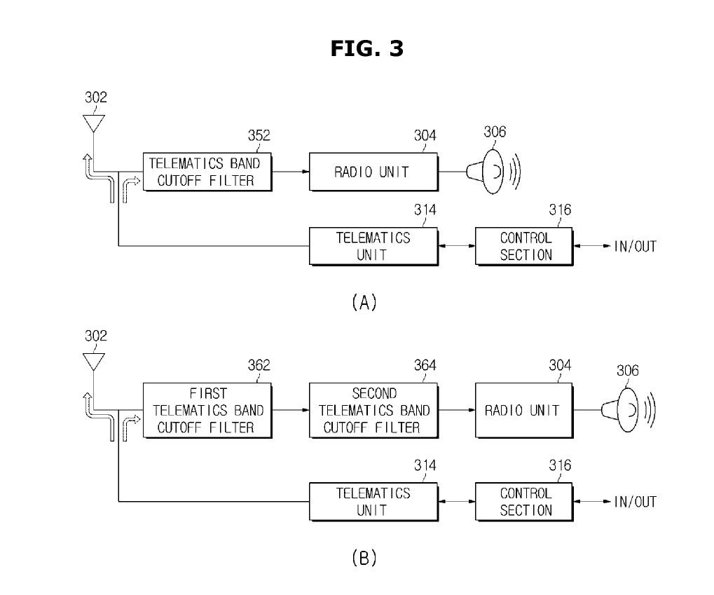

FIG. 3 is a diagram illustrating an apparatus for broadcasting and communication of a vehicle according to embodiments of the present disclosure. First, as illustrated in (A) of FIG. 3, the reception of the AM radio broadcast signal which is a broadcast signal and the transmission and reception of the telematics signal which is a communication signal are performed through one multi-band antenna 302.

An AM radio broadcast signal received through the multi-band antenna 302 is converted into a sound signal capable of being output from a speaker 306 through processes such as filtering and frequency conversion in a radio unit 304. For this, the radio unit 304 may include a reception section, a filter, a frequency conversion section, and an analog signal generation section. In addition, after a telematics reception signal received through the multi-band antenna 302 is converted into a data signal through processes such as filtering and frequency conversion in a telematics unit 314, the data signal is transferred to a control section 316. The control section 316 may be an electronic control unit (ECU) of the vehicle 100. The control section 316 may generate a necessary control signal based on the data signal obtained by the conversion.

In addition, the telematics unit 314 converts the data signal transferred from the control section 316 in the form of a telematics signal, thereby transmitting the telematics signal through the multi-band antenna 302. A modulation frequency band of the telematics transmission signal is a band of several hundred KHz. Because this band partially overlaps a modulation frequency band of 535 KHz to 1605 KHz of the AM radio signal, an inflow of a signal of a modulation frequency band of the telematics transmission signal into the radio unit 304 may occur when the telematics transmission signal transmitted from the telematics unit 314 is transmitted through the multi-band antenna 302. In the vehicle, the inflow of the signal of the modulation frequency band of the telematics transmission signal into the radio unit 304 is configured to be cut-off by installing the telematics band cutoff filter 352 on the input side of the radio unit 304.

The telematics band cutoff filter 352 cuts-off a signal of a carrier frequency band (e.g., 1.7 GHz to 2.2 GHz) of a telematics transmission signal. That is, the modulation frequency band signal of the telematics transmission signal is not cut-off, but a carrier frequency band signal is cut-off. If the signal of the modulation frequency band of the telematics transmission signal is cut-off on the input side of the radio unit 304, a partial band of an AM radio broadcast signal overlapping in frequency band is also cut-off and the reception of a radio broadcast may not be smoothly performed. Accordingly, the signal of the carrier frequency band of the telematics transmission signal is cut-off through the telematics band cutoff filter 352, so that the inflow of the telematics transmission signal into the radio unit 304 is basically cut-off and the reception of the AM radio broadcast signal may be smoothly performed.

(B) of FIG. 3 is a diagram illustrating the case in which a plurality of cutoff units are installed on the input side of the radio unit 304. As illustrated in (B) of FIG. 3, it is possible to double the effect of cutting off an inflow of a telematics transmission signal into the radio unit 304 by connecting a first telematics band cutoff filter 362 and a second telematics band cutoff filter 364 in series on a signal path between the multi-band antenna 302 and the radio unit 304.

Furthermore, in embodiments according to the present disclosure, at least one cutoff unit is provided on an input side of a broadcasting unit so that the inflow of a communication signal into the broadcasting unit is cut-off in a structure in which the broadcasting unit for receiving a broadcast signal and a communication unit for transmitting and receiving the communication signal share a single antenna. Here, the broadcasting unit may be a radio unit. In addition, the communication unit may be a telematics unit. The broadcast signal may be an AM radio broadcast signal. In addition, the communication signal may be a telematics signal. In addition, the cutoff unit may be a telematics band isolator. The telematics band isolator enables only either of the reception and transmission of a desired signal of a specific frequency band (i.e., unidirectional cutoff).

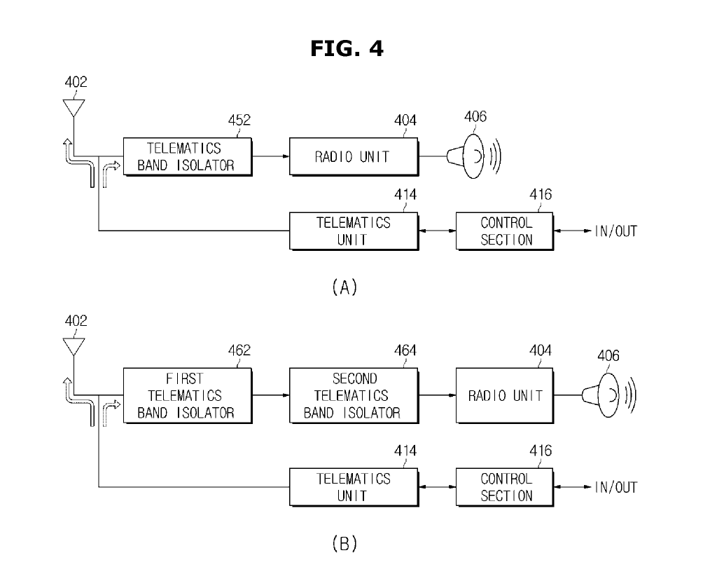

FIG. 4 is a diagram illustrating an apparatus for broadcasting and communication of a vehicle according to embodiments of the present disclosure. First, as illustrated in (A) of FIG. 4, the reception of the AM radio broadcast signal which is a broadcast signal and the transmission and reception of the telematics signal which is a communication signal are performed through one multi-band antenna 402.

An AM radio broadcast signal received through the multi-band antenna 402 is converted into a sound signal capable of being output from a speaker 406 through processes such as filtering and frequency conversion in a radio unit 404. For this, the radio unit 404 may include a reception section, a filter, a frequency conversion section, and an analog signal generation section. In addition, after a telematics reception signal received through the multi-band antenna 402 is converted into a data signal through processes such as filtering and frequency conversion in a telematics unit 414, the data signal is transferred to a control section 416. The control section 416 may be an ECU of the vehicle 100. The control section 416 may generate a necessary control signal based on the data signal obtained by the conversion.

In addition, the telematics unit 414 converts the data signal transferred from the control section 416 in the form of a telematics signal, thereby transmitting the telematics signal through the multi-band antenna 402. A modulation frequency band of the telematics transmission signal is a band of several hundred KHz. Because this band partially overlaps a modulation frequency band of 535 KHz to 1605 KHz of the AM radio signal, an inflow of a signal of a modulation frequency band of the telematics transmission signal into the radio unit 404 may occur when the telematics transmission signal transmitted from the telematics unit 414 is transmitted through the multi-band antenna 402. In the vehicle, the inflow of the signal of the modulation frequency band of the telematics transmission signal into the radio unit 404 is configured to be cut-off by installing the telematics band isolator 452 on the input side of the radio unit 404. Here, it is preferable to install the telematics band isolator 452 in a direction in which the inflow of the signal of the carrier frequency band of the telematics signal into the radio unit 404 is cut-off.

The telematics band isolator 452 cuts-off a signal of a carrier frequency band (e.g., 1.7 GHz to 2.2 GHz) of a telematics transmission signal. That is, the modulation frequency band signal of the telematics transmission signal is not cut-off, but a carrier frequency band signal is cut-off. If the signal of the modulation frequency band of the telematics transmission signal is cut-off on the input side of the radio unit 404, a partial band of an AM radio broadcast signal overlapping in frequency band is also cut-off and the reception of a radio broadcast may not be smoothly performed. Accordingly, the signal of the carrier frequency band of the telematics transmission signal is cut-off through the telematics band isolator 452, so that the inflow of the telematics transmission signal into the radio unit 404 is basically cut-off and the reception of the AM radio broadcast signal may be smoothly performed.

(B) of FIG. 4 is a diagram illustrating the case in which a plurality of cutoff units are installed on the input side of the radio unit 404. As illustrated in (B) of FIG. 4, it is possible to double the effect of cutting off an inflow of a telematics transmission signal into the radio unit 404 by connecting a first telematics band isolator 462 and a second telematics band isolator 464 in series on a signal path between the multi-band antenna 402 and the radio unit 404. Here, it is preferable to install a plurality of telematics band isolators 462 and 464 in a direction in which the inflow of the signal of the carrier frequency band of the telematics signal into the radio unit 404 is cut-off.

Furthermore, in embodiments according to the present disclosure, a plurality of cutoff units are provided on an input side of a broadcasting unit so that the inflow of a communication signal into the broadcasting unit is cut-off in a structure in which the broadcasting unit for receiving a broadcast signal and a communication unit for transmitting and receiving the communication signal share a single antenna. Here, the broadcasting unit may be a radio unit. In addition, the communication unit may be a telematics unit. The broadcast signal may be an AM radio broadcast signal. In addition, the communication signal may be a telematics signal. In addition, the cutoff unit may be a telematics band cutoff filter. The telematics band cutoff filter performs a cutoff operation of disabling both the reception and transmission of a desired signal of a specific frequency band (i.e., bidirectional cutoff). In addition, the cutoff unit may be a telematics band isolator. The telematics band isolator enables only either of the reception and transmission of a desired signal of a specific frequency band (i.e., unidirectional cutoff).

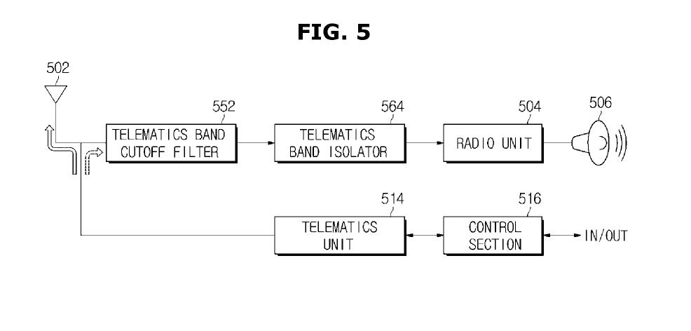

FIG. 5 is a diagram illustrating an apparatus for broadcasting and communication of a vehicle according to embodiments of the present disclosure. As illustrated in FIG. 5, the reception of the AM radio broadcast signal which is a broadcast signal and the transmission and reception of the telematics signal which is a communication signal are performed through one multi-band antenna 502.

An AM radio broadcast signal received through the multi-band antenna 502 is converted into a sound signal capable of being output from a speaker 506 through processes such as filtering and frequency conversion in a radio unit 504. For this, the radio unit 504 may include a reception section, a filter, a frequency conversion section, and an analog signal generation section. In addition, after a telematics reception signal received through the multi-band antenna 502 is converted into a data signal through processes such as filtering and frequency conversion in a telematics unit 514, the data signal is transferred to a control section 516. The control section 516 may be an ECU of the vehicle 100. The control section 516 may generate a necessary control signal based on the data signal obtained by the conversion.

In addition, the telematics unit 514 converts the data signal transferred from the control section 516 in the form of a telematics signal, thereby transmitting the telematics signal through the multi-band antenna 502. A modulation frequency band of the telematics transmission signal is a band of several hundred KHz. Because this band partially overlaps a modulation frequency band of 535 KHz to 1605 KHz of the AM radio signal, an inflow of a signal of a modulation frequency band of the telematics transmission signal into the radio unit 504 may occur when the telematics transmission signal transmitted from the telematics unit 514 is transmitted through the multi-band antenna 502. In the vehicle, the inflow of the signal of the modulation frequency band of the telematics transmission signal into the radio unit 504 is configured to be cut-off by installing a telematics band cutoff filter 552 and a telematics band isolator 564 in series on the input side of the radio unit 504. Here, it is preferable to install the telematics band isolator 564 in a direction in which the inflow of the signal of the carrier frequency band of the telematics signal into the radio unit 504 is cut-off.

The telematics band cutoff filter 552 cuts-off a signal of a carrier frequency band (e.g., 1.7 GHz to 2.2 GHz) of a telematics transmission signal. That is, the modulation frequency band signal of the telematics transmission signal is not cut-off, but a carrier frequency band signal is cut-off. If the signal of the modulation frequency band of the telematics transmission signal is cut-off on the input side of the radio unit 504, a partial band of an AM radio broadcast signal overlapping in frequency band is also cut-off and the reception of a radio broadcast may not be smoothly performed. Accordingly, the signal of the carrier frequency band of the telematics transmission signal is cut-off through the telematics band cutoff filter 552, so that the inflow of the telematics transmission signal into the radio unit 504 is basically cut-off and the reception of the AM radio broadcast signal may be smoothly performed.

The telematics band isolator 564 cuts-off a signal of a carrier frequency band (e.g., 1.7 GHz to 2.2 GHz) of a telematics transmission signal. That is, the modulation frequency band signal of the telematics transmission signal is not cut-off, but a carrier frequency band signal is cut-off. If the signal of the modulation frequency band of the telematics transmission signal is cut-off on the input side of the radio unit 504, a partial band of an AM radio broadcast signal overlapping in frequency band is also cut-off and the reception of a radio broadcast may not be smoothly performed. Accordingly, the signal of the carrier frequency band of the telematics transmission signal is cut-off through the telematics band isolator 564, so that the inflow of the telematics transmission signal into the radio unit 504 is basically cut-off and the reception of the AM radio broadcast signal may be smoothly performed.

In this manner, it is possible to double the effect of cutting off an inflow of a telematics transmission signal into the radio unit 504 by connecting the telematics band cutoff filter 552 and the telematics band isolator 564 in series on a signal path between the multi-band antenna 502 and the radio unit 504.

Furthermore, in embodiments according to the present disclosure, at least one cutoff unit is provided on an input side of a broadcasting unit so that the inflow of a communication signal into the broadcasting unit is cut-off in a structure including the broadcasting unit for receiving a broadcast signal through an antenna for receiving the broadcast signal and a communication unit for transmitting and receiving the communication signal through an antenna for receiving the communication signal. Here, the broadcasting unit may be a radio unit. In addition, the communication unit may be a telematics unit. The broadcast signal may be an AM radio broadcast signal. In addition, the communication signal may be a telematics signal. In addition, the cutoff unit may be a telematics band cutoff filter. The telematics band cutoff filter performs a cutoff operation of disabling both the reception and transmission of a desired signal of a specific frequency band (i.e., bidirectional cutoff).

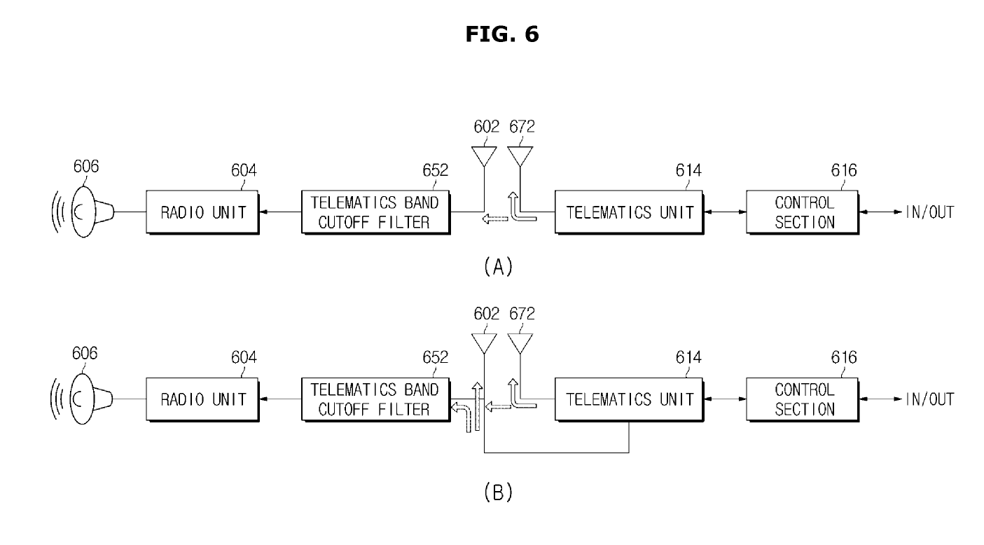

FIG. 6 is a diagram illustrating an apparatus for broadcasting and communication of a vehicle according to embodiments of the present disclosure. The apparatus for the broadcasting and communication illustrated in FIG. 6 may be an MIMO apparatus. First, as illustrated in (A) of FIG. 6, the reception of an AM radio broadcast signal which is a broadcast signal is performed through a first antenna 602 and the transmission and reception of a telematics signal which is a communication signal are performed through a second antenna 672. Here, both the first antenna 602 and the second antenna 672 are single band antennas.

An AM radio broadcast signal received through the first antenna 602 is converted into a sound signal capable of being output from a speaker 606 through processes such as filtering and frequency conversion in a radio unit 604. For this, the radio unit 604 may include a reception section, a filter, a frequency conversion section, and an analog signal generation section. In addition, after a telematics reception signal received through the second antenna 672 is converted into a data signal through processes such as filtering and frequency conversion in a telematics unit 614, the data signal is transferred to a control section 616. The control section 616 may be an ECU of the vehicle 100. The control section 616 may generate a necessary control signal based on the data signal obtained by the conversion.

In addition, the telematics unit 614 converts the data signal transferred from the control section 616 in the form of a telematics signal, thereby transmitting the telematics signal through the second antenna 672. A modulation frequency band of the telematics transmission signal is a band of several hundred KHz. Because this band partially overlaps a modulation frequency band of 535 KHz to 1605 KHz of the AM radio signal, an inflow of a signal of a modulation frequency band of the telematics transmission signal into the radio unit 604 may occur when the telematics transmission signal transmitted from the telematics unit 614 is transmitted through the second antenna 672. In the vehicle, the inflow of the signal of the modulation frequency band of the telematics transmission signal into the radio unit 604 is configured to be cut-off by installing a telematics band cutoff filter 652 on the input side of the radio unit 604.

The telematics band cutoff filter 652 cuts-off the signal of the carrier frequency band (e.g., 1.7 GHz to 2.2 GHz) of the telematics transmission signal. That is, the modulation frequency band signal of the telematics transmission signal is not cut-off, but a carrier frequency band signal is cut-off. If the signal of the modulation frequency band of the telematics transmission signal is cut-off on the input side of the radio unit 604, a partial band of an AM radio broadcast signal overlapping in frequency band is also cut-off and the reception of a radio broadcast may not be smoothly performed. Accordingly, the signal of the carrier frequency band of the telematics transmission signal is cut-off through the telematics band cutoff filter 652, so that the inflow of the telematics transmission signal into the radio unit 604 is basically cut-off and the reception of the AM radio broadcast signal may be smoothly performed.

(B) of FIG. 6 is a diagram illustrating the case in which one of a plurality of antennas is a single band antenna and another antenna is a multi-band antenna. As illustrated in (B) of FIG. 6, in the vehicle according to embodiments of the present disclosure, the reception of an AM radio broadcast signal which is a broadcast signal and the transmission and reception of a telematics signal is performed through a first antenna 602 and the transmission and reception of a telematics signal which is a communication signal are performed through a second antenna 672. Here, the first antenna 602 is a multi-band antenna for an AM radio broadcast signal and a telematics signal and the second antenna 672 is a single band antenna for only the telematics signal.

An AM radio broadcast signal received through the first antenna 602 is converted into a sound signal capable of being output from a speaker 606 through processes such as filtering and frequency conversion in a radio unit 604. For this, the radio unit 604 may include a reception section, a filter, a frequency conversion section, and an analog signal generation section. In addition, after a telematics reception signal received through the first antenna 602 is converted into a data signal through processes such as filtering and frequency conversion in a telematics unit 614, the data signal is transferred to a control section 616. In addition, after a telematics reception signal received through the second antenna 672 is also converted into a data signal through processes such as filtering and frequency conversion in the telematics unit 614, the data signal is transferred to the control section 616. The control section 616 may be an ECU of the vehicle 100. The control section 616 may generate a necessary control signal based on the data signal obtained by the conversion.

In addition, the telematics unit 614 converts the data signal transferred from the control section 616 in the form of a telematics signal, thereby transmitting the telematics signal through the first antenna 602 and the second antenna 672. A modulation frequency band of the telematics transmission signal is a band of several hundred KHz. Because this band partially overlaps a modulation frequency band of 535 KHz to 1605 KHz of the AM radio signal, an inflow of a signal of a modulation frequency band of the telematics transmission signal into the radio unit 604 may occur when the telematics transmission signal transmitted from the telematics unit 614 is transmitted through the first antenna 602 and the second antenna 672. In the vehicle, the inflow of the signal of the modulation frequency band of the telematics transmission signal transmitted from the telematics unit 614 into the radio unit 604 is configured to be cut-off by installing a telematics band cutoff filter 652 on the input side of the radio unit 604. As in the case of (A) of FIG. 6, the telematics band cutoff filter 652 of (B) of FIG. 6 cuts-off a signal of a carrier frequency band (e.g., 1.7 GHz to 2.2 GHz) of a telematics transmission signal.

Furthermore, in embodiments according to the present disclosure, at least one cutoff unit is provided on an input side of a broadcasting unit so that the inflow of a communication signal into the broadcasting unit is cut-off in a structure including the broadcasting unit for receiving a broadcast signal through an antenna for receiving the broadcast signal and a communication unit for transmitting and receiving the communication signal through an antenna for receiving the communication signal. Here, the broadcasting unit may be a radio unit. In addition, the communication unit may be a telematics unit. The broadcast signal may be an AM radio broadcast signal. In addition, the communication signal may be a telematics signal. In addition, the cutoff unit may be a telematics band isolator. The telematics band isolator enables only either of the reception and transmission of a desired signal of a specific frequency band (i.e., unidirectional cutoff).

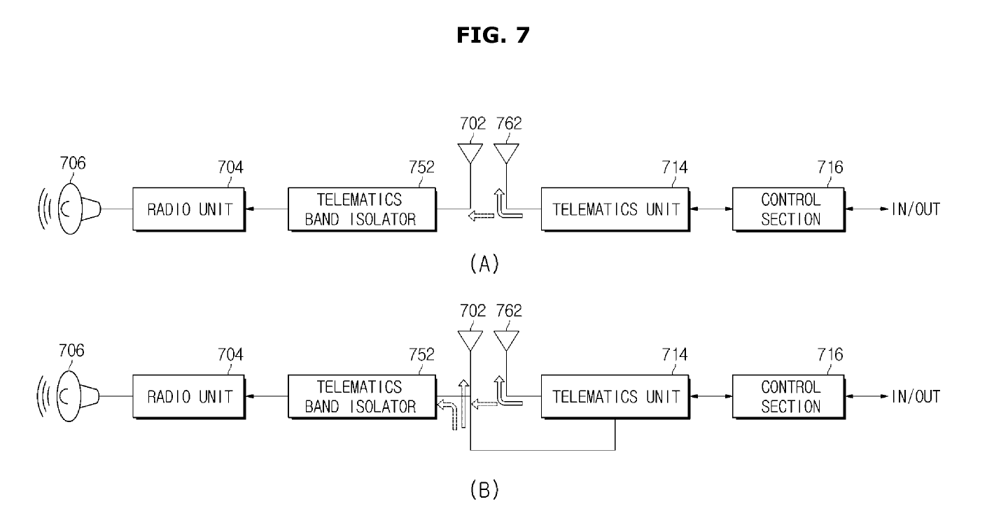

FIG. 7 is a diagram illustrating an apparatus for broadcasting and communication of a vehicle according to embodiments of the present disclosure. The apparatus for the broadcasting and communication illustrated in FIG. 7 may be an MIMO apparatus. First, as illustrated in (A) of FIG. 7, the reception of an AM radio broadcast signal which is a broadcast signal is performed through a first antenna 702 and the transmission and reception of a telematics signal which is a communication signal are performed through a second antenna 772. Here, both the first antenna 702 and the second antenna 772 are single band antennas.

An AM radio broadcast signal received through the first antenna 702 is converted into a sound signal capable of being output from a speaker 706 through processes such as filtering and frequency conversion in a radio unit 704. For this, the radio unit 704 may include a reception section, a filter, a frequency conversion section, and an analog signal generation section. In addition, after a telematics reception signal received through the second antenna 772 is converted into a data signal through processes such as filtering and frequency conversion in a telematics unit 714, the data signal is transferred to a control section 716. The control section 716 may be an ECU of the vehicle 100. The control section 716 may generate a necessary control signal based on the data signal obtained by the conversion.

In addition, the telematics unit 714 converts the data signal transferred from the control section 716 in the form of a telematics signal, thereby transmitting the telematics signal through the second antenna 772. A modulation frequency band of the telematics transmission signal is a band of several hundred KHz. Because this band partially overlaps a modulation frequency band of 535 KHz to 1605 KHz of the AM radio signal, an inflow of a signal of a modulation frequency band of the telematics transmission signal into the radio unit 704 may occur when the telematics transmission signal transmitted from the telematics unit 714 is transmitted through the second antenna 772. In the vehicle, the inflow of the signal of the modulation frequency band of the telematics transmission signal into the radio unit 704 is configured to be cut-off by installing a telematics band isolator 752 on the input side of the radio unit 704. Here, it is preferable to install the telematics band isolator 752 in a direction in which the inflow of the signal of the carrier frequency band of the telematics signal into the radio unit 704 is cut-off.

The telematics band isolator 752 cuts-off a signal of a carrier frequency band (e.g., 1.7 GHz to 2.2 GHz) of a telematics transmission signal. That is, the modulation frequency band signal of the telematics transmission signal is not cut-off, but a carrier frequency band signal is cut-off. If the signal of the modulation frequency band of the telematics transmission signal is cut-off on the input side of the radio unit 704, a partial band of an AM radio broadcast signal overlapping in frequency band is also cut-off and the reception of a radio broadcast may not be smoothly performed. Accordingly, the signal of the carrier frequency band of the telematics transmission signal is cut-off through the telematics band isolator 752, so that the inflow of the telematics transmission signal into the radio unit 704 is basically cut-off and the reception of the AM radio broadcast signal may be smoothly performed.

(B) of FIG. 7 is a diagram illustrating the case in which one of a plurality of antennas is a single band antenna and another antenna is a multi-band antenna. As illustrated in (B) of FIG. 7, in the vehicle according to embodiments of the present disclosure, the reception of an AM radio broadcast signal which is a broadcast signal and the transmission and reception of a telematics signal is performed through a first antenna 702 and the transmission and reception of a telematics signal which is a communication signal are performed through a second antenna 772. Here, the first antenna 702 is a multi-band antenna for an AM radio broadcast signal and a telematics signal and the second antenna 772 is a single band antenna for only the telematics signal.

An AM radio broadcast signal received through the first antenna 702 is converted into a sound signal capable of being output from a speaker 706 through processes such as filtering and frequency conversion in a radio unit 704. For this, the radio unit 704 may include a reception section, a filter, a frequency conversion section, and an analog signal generation section. In addition, after a telematics reception signal received through the first antenna 702 is converted into a data signal through processes such as filtering and frequency conversion in the telematics unit 714, the data signal is transferred to the control section 716. In addition, after a telematics reception signal received through the second antenna 772 is also converted into a data signal through processes such as filtering and frequency conversion in the telematics unit 714, the data signal is transferred to the control section 716. The control section 716 may be an ECU of the vehicle 100. The control section 716 may generate a necessary control signal based on the data signal obtained by the conversion.

In addition, the telematics unit 714 converts the data signal transferred from the control section 716 in the form of a telematics signal, thereby transmitting the telematics signal through the first antenna 702 and the second antenna 772. A modulation frequency band of the telematics transmission signal is a band of several hundred KHz. Because this band partially overlaps a modulation frequency band of 535 KHz to 1605 KHz of the AM radio signal, an inflow of a signal of a modulation frequency band of the telematics transmission signal into the radio unit 704 may occur when the telematics transmission signal transmitted from the telematics unit 714 is transmitted through the first antenna 702 and the second antenna 772. In the vehicle, the inflow of the signal of the modulation frequency band of the telematics transmission signal transmitted from the telematics unit 714 into the radio unit 704 is configured to be cut-off by installing a telematics band isolator 752 on the input side of the radio unit 704. As in the case of (A) of FIG. 7, the telematics band isolator 752 of (B) of FIG. 7 cuts-off a signal of a carrier frequency band (e.g., 1.7 GHz to 2.2 GHz) of a telematics transmission signal.

Furthermore, in embodiments according to the present disclosure, at least one cutoff unit is provided on an input side of a broadcasting unit so that the inflow of a communication signal into the broadcasting unit is cut-off in a structure in which the broadcasting unit for receiving a broadcast signal and a communication unit for transmitting and receiving the communication signal share a single antenna. Here, the broadcasting unit may be a radio unit. In addition, the communication unit may be a telematics unit. The broadcast signal may be an AM radio broadcast signal. In addition, the communication signal may be a telematics signal. In addition, the cutoff unit may be a telematics band cutoff filter. The telematics band cutoff filter performs a cutoff operation of disabling both the reception and transmission of a desired signal of a specific frequency band (i.e., bidirectional cutoff).

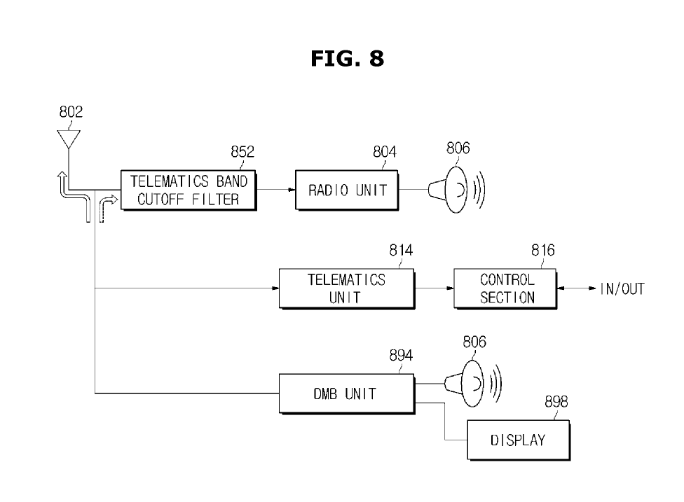

FIG. 8 is a diagram illustrating an apparatus for broadcasting and communication of a vehicle according to embodiments of the present disclosure. As illustrated in FIG. 8, the reception of the AM radio broadcast signal which is a broadcast signal, the transmission and reception of the telematics signal which is a communication signal, and the reception of another broadcast signal (e.g., a digital multimedia broadcasting (DMB) broadcast signal) are performed through one multi-band antenna 802.

An AM radio broadcast signal received through the multi-band antenna 802 is converted into a sound signal capable of being output from a speaker 806 through processes such as filtering and frequency conversion in a radio unit 804. For this, the radio unit 804 may include a reception section, a filter, a frequency conversion section, and an analog signal generation section. In addition, after a telematics reception signal received through the multi-band antenna 802 is converted into a data signal through processes such as filtering and frequency conversion in a telematics unit 814, the data signal is transferred to a control section 816. The control section 816 may be an ECU of the vehicle 100. The control section 816 may generate a necessary control signal based on the data signal obtained by the conversion. After the DMB broadcast signal received through the multi-band antenna 802 is converted into a data signal through processes such as filtering and frequency conversion in a DMB unit 894, the data signal is transferred to the speaker 806 and a display 898. The speaker 806 outputs a DMB broadcast sound and the display 898 outputs a DMB broadcast video.

In addition, the telematics unit 814 converts the data signal transferred from the control section 816 in the form of a telematics signal, thereby transmitting the telematics signal through the multi-band antenna 802. A modulation frequency band of the telematics transmission signal is a band of several hundred KHz. Because this band partially overlaps a modulation frequency band of 535 KHz to 1605 KHz of the AM radio signal, an inflow of a signal of a modulation frequency band of the telematics transmission signal into the radio unit 804 may occur when the telematics transmission signal transmitted from the telematics unit 814 is transmitted through the multi-band antenna 802. In the vehicle according to embodiments of the present disclosure, the inflow of the signal of the modulation frequency band of the telematics transmission signal into the radio unit 804 is configured to be cut-off by installing the telematics band cutoff filter 852 on the input side of the radio unit 804.

The telematics band cutoff filter 852 cuts-off a signal of a carrier frequency band (e.g., 1.7 GHz to 2.2 GHz) of a telematics transmission signal. That is, the modulation frequency band signal of the telematics transmission signal is not cut-off, but a carrier frequency band signal is cut-off. If the signal of the modulation frequency band of the telematics transmission signal is cut-off on the input side of the radio unit 804, a partial band of an AM radio broadcast signal overlapping in frequency band is also cut-off and the reception of a radio broadcast may not be smoothly performed. Accordingly, the signal of the carrier frequency band of the telematics transmission signal is cut-off through the telematics band cutoff filter 852, so that the inflow of the telematics transmission signal into the radio unit 804 is basically cut-off and the reception of the AM radio broadcast signal may be smoothly performed.

Furthermore, in embodiments according to the present disclosure, at least one cutoff unit is provided on an input side of a broadcasting unit so that the inflow of a communication signal into the broadcasting unit is cut-off in a structure in which the broadcasting unit for receiving a broadcast signal and a communication unit for transmitting and receiving the communication signal share a single antenna. Here, the broadcasting unit may be a radio unit. In addition, the communication unit may be a telematics unit. The broadcast signal may be an AM radio broadcast signal. In addition, the communication signal may be a telematics signal. In addition, the cutoff unit may be a telematics band isolator. The telematics band isolator enables only either of the reception and transmission of a desired signal of a specific frequency band (i.e., unidirectional cutoff).

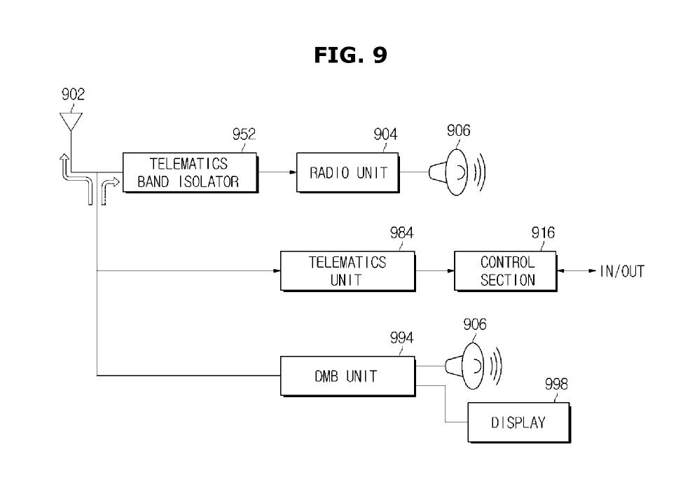

FIG. 9 is a diagram illustrating an apparatus for broadcasting and communication of a vehicle according to embodiments of the present disclosure. First, as illustrated in FIG. 9, the reception of the AM radio broadcast signal which is a broadcast signal, the transmission and reception of the telematics signal which is a communication signal, and the reception of another broadcast signal (e.g., a DMB broadcast signal) are performed through one multi-band antenna 902.

An AM radio broadcast signal received through the multi-band antenna 902 is converted into a sound signal capable of being output from a speaker 906 through processes such as filtering and frequency conversion in a radio unit 904. For this, the radio unit 904 may include a reception section, a filter, a frequency conversion section, and an analog signal generation section. In addition, after a telematics reception signal received through the multi-band antenna 902 is converted into a data signal through processes such as filtering and frequency conversion in a telematics unit 914, the data signal is transferred to a control section 916. The control section 916 may be an ECU of the vehicle 100. The control section 916 may generate a necessary control signal based on the data signal obtained by the conversion. After the DMB broadcast signal received through the multi-band antenna 902 is converted into a data signal through processes such as filtering and frequency conversion in a DMB unit 994, the data signal is transferred to the speaker 906 and a display 998. The speaker 906 outputs a DMB broadcast sound and the display 998 outputs a DMB broadcast video.

In addition, the telematics unit 914 converts the data signal transferred from the control section 916 in the form of a telematics signal, thereby transmitting the telematics signal through the multi-band antenna 902. A modulation frequency band of the telematics transmission signal is a band of several hundred KHz. Because this band partially overlaps a modulation frequency band of 535 KHz to 1605 KHz of the AM radio signal, an inflow of a signal of a modulation frequency band of the telematics transmission signal into the radio unit 904 may occur when the telematics transmission signal transmitted from the telematics unit 914 is transmitted through the multi-band antenna 902. In the vehicle the inflow of the signal of the modulation frequency band of the telematics transmission signal into the radio unit 904 is configured to be cut-off by installing a telematics band isolator 952 on the input side of the radio unit 904. Here, it is preferable to install the telematics band isolator 952 in a direction in which the inflow of the signal of the carrier frequency band of the telematics signal into the radio unit 904 is cut-off.

The telematics band isolator 952 cuts-off a signal of a carrier frequency band (e.g., 1.7 GHz to 2.2 GHz) of a telematics transmission signal. That is, the modulation frequency band signal of the telematics transmission signal is not cut-off, but a carrier frequency band signal is cut-off. If the signal of the modulation frequency band of the telematics transmission signal is cut-off on the input side of the radio unit 904, a partial band of an AM radio broadcast signal overlapping in frequency band is also cut-off and the reception of a radio broadcast may not be smoothly performed. Accordingly, the signal of the carrier frequency band of the telematics transmission signal is cut-off through the telematics band isolator 952, so that the inflow of the telematics transmission signal into the radio unit 904 is basically cut-off and the reception of the AM radio broadcast signal may be smoothly performed.

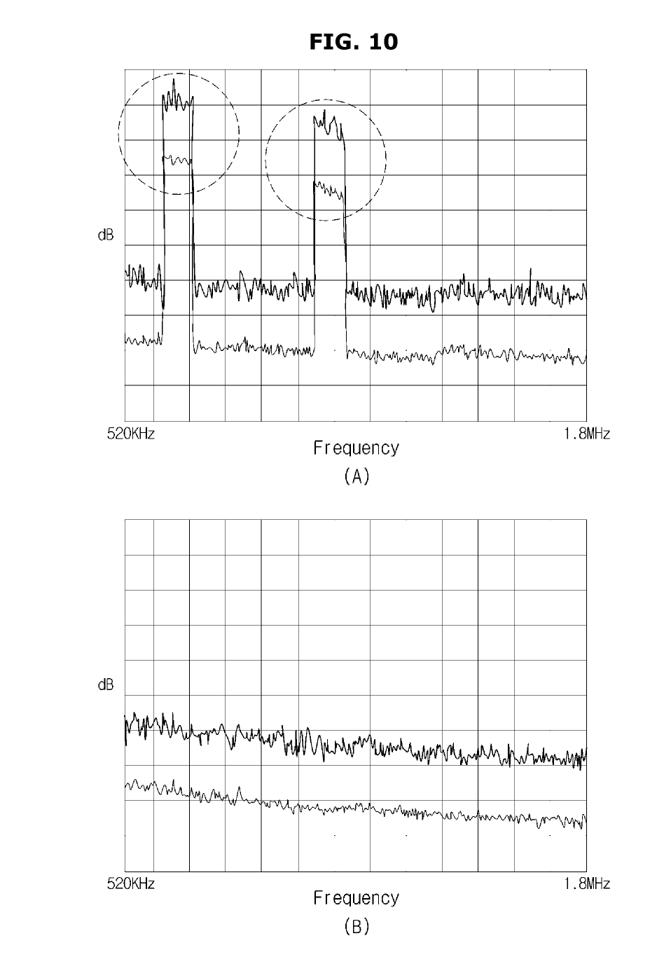

FIG. 10 is a diagram illustrating noise characteristics of an antenna in a vehicle according to embodiments of the present disclosure. (A) of FIG. 10 is noise characteristics shown on an input side of a radio unit in a state in which a telematics band cutoff filter or a telematics band isolator according to embodiments of the preset disclosure is not applied. (B) of FIG. 10 illustrates noise characteristics shown on the input side of the radio unit in a state in which the telematics band cutoff filter or the telematics band isolator according to embodiments of the preset disclosure is applied.

As illustrated in (A) of FIG. 10, it can be seen that noise of an AM radio broadcast band is shown in at least two positions on the input side of the radio unit in the state in which the telematics band cutoff filter or the telematics band isolator according to embodiments of the preset disclosure is not applied. This noise is caused by an inflow of a signal of a modulation frequency band of the telematics signal transmitted from the telematics unit into the radio unit in a process in which the signal of the modulation frequency band of the telematics is transmitted through an antenna.

In embodiments of the present disclosure, the inflow of the telematics signal into the radio unit is prevented by installing the telematics band cutoff filter or the telematics band isolator on the input side of the radio unit, so that the noise does not occur in the input side of the radio units as illustrated in (B) of FIG. 10.

While the contents of the present disclosure have been described in connection with what is presently considered to be embodiments, it is to be understood that the disclosure is not limited to the disclosed embodiments, but, on the contrary, is intended to cover various modifications and equivalent arrangements included within the spirit and scope of the appended claims.

What is claimed is:

1. A vehicle comprising:
a single antenna;
a broadcasting unit configured to receive a broadcast signal through the single antenna;
a communication unit configured to transmit and receive a communication signal through the single antenna; and
at least one cutoff unit provided on an input side of the broadcasting unit and configured to cut-off an inflow of the communication signal to the broadcasting unit.

2. The vehicle according to claim 1, wherein the single antenna is a multi-band antenna.

3. The vehicle according to claim 1, wherein:
the broadcast signal is a radio broadcast signal, and
the communication signal is a telematics signal.

4. The vehicle according to claim 3, wherein the at least one cutoff unit includes a band cutoff filter configured to cut-off a signal of a carrier frequency band of the telematics signal.

5. The vehicle according to claim 3, wherein the at least one cutoff unit includes a band isolator configured to cut-off a signal of a carrier frequency band of the telematics signal.

6. The vehicle according to claim 5, wherein the band isolator is installed in a direction in which an inflow of the signal of the carrier frequency band of the telematics signal to the broadcasting unit is cut-off.

7. The vehicle according to claim 3, wherein the at least one cutoff unit includes at least one band cutoff filter and at least one band isolator connected in series to cut-off a signal of a carrier frequency band of the telematics signal.

8. The vehicle according to claim 1, further comprising:
another broadcasting unit configured to receive another broadcast signal through the single antenna.

9. A vehicle comprising:
a first antenna;
a second antenna installed near the first antenna;
a broadcasting unit configured to receive a broadcast signal through the first antenna;
a communication unit configured to transmit and receive a communication signal through the second antenna; and
at least one cutoff unit provided on an input side of the broadcasting unit and configured to cut-off an inflow of the communication signal to the broadcasting unit.

10. The vehicle according to claim 9, wherein:
the broadcast signal is a radio broadcast signal, and
the communication signal is a telematics signal.

11. The vehicle according to claim 10, wherein the at least one cutoff unit includes a band cutoff filter configured to cut-off a signal of a carrier frequency band of the telematics signal.

12. The vehicle according to claim 10, wherein the at least one cutoff unit includes a band isolator configured to cut-off a signal of a carrier frequency band of the telematics signal.

13. The vehicle according to claim 12, wherein the band isolator is installed in a direction in which an inflow of the signal of the carrier frequency band of the telematics signal to the broadcasting unit is cut-off.

14. The vehicle according to claim 10, wherein the at least one cutoff unit includes at least one band cutoff filter and at least one band isolator connected in series to cut-off a signal of a carrier frequency band of the telematics signal.

15. A broadcasting unit comprising:
a reception section configured to share a single antenna with a communication unit and receive a broadcast signal through the single antenna; and
at least one cutoff unit provided on an input side of the reception section and configured to cut-off an inflow of a communication signal to the reception section.

16. The broadcasting unit according to claim 15, wherein the single antenna is a multi-band antenna.

17. The broadcasting unit according to claim 15, wherein:
the broadcast signal is a radio broadcast signal, and
the communication signal is a telematics signal.

18. The broadcasting unit according to claim 17, wherein the at least one cutoff unit includes a band cutoff filter configured to cut-off a signal of a carrier frequency band of the telematics signal.

19. The broadcasting unit according to claim 17, wherein the at least one cutoff unit includes a band isolator configured to cut-off a signal of a carrier frequency band of the telematics signal.

20. The broadcasting unit according to claim 19, wherein the band isolator is installed in a direction in which an inflow of the signal of the carrier frequency band of the telematics signal to the broadcasting unit is cut-off.

21. An apparatus for broadcasting and communication, the apparatus comprising:
a single antenna;
a broadcasting unit configured to receive a broadcast signal through the single antenna;
a communication unit configured to transmit and receive a communication signal through the single antenna; and
at least one cutoff unit provided on an input side of the broadcasting unit and configured to cut-off an inflow of the communication signal to the broadcasting unit.

22. The apparatus for the broadcasting and communication according to claim 21, wherein the single antenna is a multi-band antenna.

23. The apparatus for the broadcasting and communication according to claim 21, wherein:
the broadcast signal is a radio broadcast signal, and
the communication signal is a telematics signal.
